(19) United States
(12) Patent Application Publication
(10) Pub. No.: US 2013/0093403 A1
(43) Pub. Date: Apr. 18, 2013

(54) Methods and Circuits for Improving the Dynamic Response of a DC-DC Converter

(71) Applicants: Liang Jia, Des Plains, IL (US); Yan-Fei Liu, Kingston (CA)

(72) Inventors: Liang Jia, Des Plains, IL (US); Yan-Fei Liu, Kingston (CA)

(21) Appl. No.: 13/608,447

(22) Filed: Sep. 10, 2012

Related U.S. Application Data
(60) Provisional application No. 61/533,006, filed on Sep. 9, 2011.

(30) Foreign Application Priority Data
Sep. 9, 2011 (CA) 2751915

(51) Int. Cl. G05F 1/614

(52) U.S. Cl. CPC G05F 1/614
USPC 323/272

(57) ABSTRACT

Methods and circuits are described herein which may be used to improve the unloading transient response of a DC-DC converter. In some embodiments the transient response may be improved by improving the way MOSFET switches in the buck converter are controlled at the point in time when a current transient is detected, and subsequently during the transient, in such a way that the impact of the current transient is mitigated. In other embodiments an auxiliary current source is used to provide rapid transient response required by the overall power converter, leaving the main portion of the DC-DC converter to provide long term stability.

### RELATED APPLICATION

This application claims the benefit of the filing date of U.S. application Ser. No. 61/533,006, filed Sep. 9, 2011, the contents of which are included herein by reference in their entirety.

### FIELD

This invention relates to methods and circuits for improving the dynamic response of a DC-DC converter to unloading current transients and loading current transients. In particular, methods and circuits are provided for suppressing voltage overshoot during an unloading current transient of a DC-DC converter.

### BACKGROUND

As the computing capabilities of high-performance digital devices continue to expand, the demand on power supplies for powering such devices becomes increasingly stringent. Advanced controllers which improve the transient performance of Buck converters have been proposed, in [1]-[14], controllers have been proposed which apply second-order sliding surfaces, pre-calculated switching time intervals, or capacitor charge balance methodologies to reduce the voltage deviation and settling time of a Buck converter, undergoing a load transient, to its virtually optimal level. However, in [1], [6], it was demonstrated that for a commonly used 12 V-1.5 V voltage converter under optimal control an undesired large output voltage overshoot still dominates the output capacitance requirement, because of the poor unloading response performance. To address the asymmetrical response, a two-stage power conversion scheme was presented in [12]. This approach used a 5 V intermediate dc bus voltage to balance the stage conversion ratio close to 50%, but added power loss and cost and required more board space.

Auxiliary circuits for reducing the output voltage overshoot were reviewed in [14], and may have one or more of the following advantages; 1) predictable behavior allowing for simplified design; 2) inherent over-current protection; and 3) low peak current to average current ratio, allowing for use of smaller components. However, the auxiliary circuit operates at very high switching frequency (e.g., 3 to 5 MHz) during activation, under a relatively complex current mode control law, which downgrades the enhancement if applied to a multiphase Buck converter. In [15], another overshoot reduction solution using the aforementioned auxiliary circuit with an external, energy storage capacitor and synchronous rectifier implementation was provided. However, the practicality of this design is. limited due to the requirement for an additional linear compensator, the subsequent high frequency switching of the auxiliary circuit, and the unimproved settling time.

### SUMMARY

Methods and circuits are provided herein which may he used to improve loading and/or unloading transient responses, of a DC-DG converter. The methods described herein include features to suppress voltage overshoot during m unloading transient and to reduce power loss.

In some embodiments the transient response is improved, by improving the way MOSFET switches in the converter are controlled at the point in time when a current transient is detected, and subsequently during the transient, in such a way that the impact of the current transient is mitigated. In other embodiments an auxiliary current source is used to provide rapid transient response required by the overall power converter, leaving the main portion of the DC-DC converter to provide long term stability. In one embodiment an auxiliary circuit is controlled by a peak current mode method for a selected number of auxiliary switching cycles, while a charge balance controller minimizes the settling time of the voltage converter.

Methods described herein may be implemented in digital and/or analog domains. Analog embodiments provided herein may include a voltage detector to detect capacitor current zero crossing moment. Embodiments may include OP AMP and comparator (OP-COM) circuitry to carry out charge balance.

Provided herein is a method for operating a DC-DO converter; comprising: using a controlled auxiliary current to divert current from an output capacitor of the DC-DC converter to an input of the DC-DC converter during a load current step; wherein controlling the controlled auxiliary current comprises using at least one switch and operating the at least one switch for a selected constant number of switching cycles; wherein the method minimizes output voltage deviation of the DC-DC-converter (luring the load current step.

In various embodiments the method may include minimizing output voltage deviation of the DC-DC converter during an unloading load current step and/or a loading current step.

Provided herein is a DC-DC converter; comprising: a controlled auxiliary current circuit comprising at least one auxiliary switch that diverts current from an output capacitor of the DC-DC converter to an input of the DC-DC converter during a load current step; and a control circuit that controls operation of this controlled auxiliary current circuit; wherein the control circuit operates the at least one auxiliary switch for a selected constant number of switching cycles to divert current from the output capacitor of the DC-DC converter to the input of the DC-DC converter during the load current step; wherein the controlled, auxiliary current circuit minimizes output voltage deviation of the DC-DC converter during the loading current step.

In various embodiments the DC-DC converter may minimize output voltage deviation of the DC-DC converter during an unloading load current step and/or a loading current step.

Provided herein is a controller for a DC-DC converter; comprising: a circuit that minimizes output voltage deviation of the DC-DC converter during an unloading output current step or a loading output current step.

In one embodiment the controller comprises a circuit that controls operation of an auxiliary current circuit including at least one auxiliary switch that diverts current from an output capacitor of the DC-DC converter to an input of the DC-DC converter during an unloading current step; wherein the circuit operates the at least one auxiliary switch for a selected number of switching cycles to divert current from tine output capacitor of the DC-DC converter to the input of the DC-DC converter daring the unloading current step; wherein the auxiliary current circuit minimizes output voltage deviation of the DC-DC converter during the unloading current step.

In one embodiment the controller includes a circuit that uses peak current mode-boundary condition mode to control the auxiliary current circuit.

In one embodiment the controller includes a circuit that determines the selected number of switching cycles based on parameters of the DC-DC converter, including input and output voltage information and a ratio of output inductor and auxiliary inductor values.

In one embodiment the controller includes a circuit that activates the auxiliary current, sets a peak current level, and deactivates the auxiliary current when the auxiliary current reaches the peak current level. The controller may set a switching frequency of the auxiliary switch.

In one embodiment the controller may be used to control a Buck converter.

Also provided herein are methods and circuits substantially in accordance with the embodiments described in Appendices A to E.

### BRIEF DESCRIPTION OF THE DRAWINGS

For a more complete understanding of the invention, and to show more clearly how it may be carried into effect, embodiments of the invention will be described, by way of example, with reference to the accompanying drawings, wherein:

FIG. 1 is a simplified schematic diagram of a controlled auxiliary current (CAC) circuit, modelled as a current source, according to one embodiment, as implemented with a Buck converter;

FIG. 2 is a simplified schematic diagram of an embodiment of a CAC circuit implemented with a Buck converter;

FIG. 3 is a plot showing boundary condition mode (BCM) peak current mode (PCM) operation waveforms of the CAC and normal CBC operation waveforms;

FIG. 4 is a plot showing estimated voltage overshoot for various output capacitances with and without BCM PCM CAC for an unloading transient of 10 A, where (Vᵢₙ=12 V, V₀=1.5 V, L₀=1 uH, Lₐᵤₓ−100 nH);

FIG. 5 is a plot showing number of auxiliary switching cycles n (as well as the ratio of L₀/Lₐᵤₓ) and the auxiliary inductance value under different output voltages V₀;

FIGS. 6(a) and (b) are plots showing the effect of a rounding down operation of n on the settling time, (a) for [(Vᵢₙ-V₀)/Vᵢₙ*L₀/Lₐᵤₓ]−n <0.5; (b) for [(Vᵢₙ-V₀)/Vᵢₙ*L₀/Lₐᵤₓ]−n≧0.5;

FIG. 7 is a plot showing estimated voltage overshoot for various times of CAC switching and different output capacitances for an unloading transient of 10 A (Vᵢₙ=12 V, V₀=1.5 V, L₀=1 uH);

FIGS. 8(a) and (b) are plots showing controlled auxiliary current switching for n switching cycles obtained by selecting different Lₐᵤₓ: (a) n=1, Lₐᵤₓ=875 nH; (b) n=5, Lₐᵤₓ=175 nH (Vᵢₙ=12 V, V₀=1.5 V, L₀=1 uH);

FIG. 9 is a plot of switching frequency ∫ₐᵤₓ versus number n of switching cycles;

FIG. 10 is a plot comparing results of loss breakdown based on different control schemes (power circuit design parameters: V₀=1.5 V, ƒₛ=450 kHz, L₀=1 uH, R_{L}=1 mΩ, Lₐᵤₓ=100 nH, RLₐᵤₓ=0.2 mΩ, RQₐᵤₓ=30 mΩ, V_{diode}=0.32 V, T_{fall}=2 ns);

FIG. 11 is a plot of switching loss of the auxiliary MOSFET versus the number n of auxiliary switching cycles under various unloading transients (power circuit design parameters: V₀=V_{ref}=1.5 V, fₛ=450 kHz, T_{fall}=2 ns);

FIG. 12 is a diagram of a hardware implementation of the a BCM PCM CAC according to one embodiment;

FIG. 13 shows simulation results of a CBC controller under a 10 A to 0 A unloading transient without CAC for a single phase Buck converter;

FIG. 14 shows simulation results of CBC controller under a 10 A to 0 A unloading transient with CAC for a single phase Buck converter;

FIG. 15 shows experimental results of an analog CBC controller under 10 A to 0 A unloading transient without CAC; and

FIG. 16 shows experimental results of a BCM PCM controller under a 10 A to 0 A unloading transient with CAC.

Further embodiments are described, by way of example, with reference to the drawings provided in Appendices A to B.

### DETAILED DESCRIPTION OF EMBODIMENTS

Buck converters are widely used in a range of applications to convert higher DC voltages to lower DC voltages, as required in an electronic system by various elements within the system. In some instances, the Buck converter must provide high stability. In other instances, fast response to transient loads is critical. Often these requirements are in conflict with each other.

Methods and circuits are described herein which may be used to improve the unloading transient response of a DC-DC Buck converter. In some embodiments the transient response may be improved by improving the way MOSFET switches in the buck converter are controlled at the point in time when a current transient is detected, and subsequently during the transient, in such a way that the impact of the current transient is mitigated. The transient condition may be detected using digital or analog techniques, and the Buck converter may be turned off and on during the transient to minimize the voltage deviation. The times at which the buck converter is either turned on or off may be calculated or estimated according to various methods, in accordance generally with a charge balance control approach (see Appendices A through E).

Additionally, methods and circuits are described herein which may be used to improve the unloading, transient response of a DC-DC Buck converter; though the use of an auxiliary current source. The auxiliary current source may be used to provide rapid transient response required by the overall power converter, leaving the main portion of the Buck converter to provide long term stability. The transient condition may be detected using digital or analog techniques, and the auxiliary current source may be turned on and off during the transient to minimize the voltage deviation. The times at which the Buck converter is either turned on or off may be calculated or estimated according to various methods, in accordance generally with a charge balance control approach, as described herein.

For example, one embodiment comprising a digital charge balanced controller (CBC) is described in detail in Appendix A. An OPAMP based voltage detector is employed tor low equivalent series resistance (ESR) Buck converters. The digital CBC controller is more accurate and cost effective than the previous controller schemes such as those using last ADC and/or current sensing techniques. Also, the control algorithm may he easily extended to adaptive voltage positioning (AVP) applications for modern CPUs, Other than low ESR. (e.g.,. less than 5 mOhm), the digital algorithm is not sensitive to any other design parameter, such as capacitance and inductance parameters. Another feature of this algorithm is that it is also improves fast input voltage transient performance without modification, i.e., the same circuit is used. Furthermore, the digital algorithm does not include complex calculations, such as division or square root, providing for analog implementation (an example of which is described in Appendix. C),

Another embodiment, is described in Appendix B, According to this embodiment, when the design parameters of a Buck converter are unknown, including the ESR value (i.e., it could be large or small), a, parabolic fitting method is used to detect critical timing information for optimal sequences of control. After constant-rate sampling for three voltage samples, a tilted voltage reference is built and employed tor time detection. As the algorithm is parameter-independents it is extremely robust, Furthermore, the digital algorithm does not include any complex calculation, providing for analog implementation (an example of which is described in Appendix D)

Another embodiment, described in Appendix E, extends tire utility of the embodiments in Appendices A and C to large ESR Buck converters. Here, an ESR and equivalent series inductance (ESL) cancellation circuit is described for minimizing ESR and ESL effects on the time detection accuracy of the algorithms. An OPAMP based feedback network is employed at the converter output to compensate the ESR and ESL effects. Another feature of this circuit is suppression of second order ringing of the output capacitor voltage caused by resonance between the capacitance and ESL under a large and ultra-fast load step transient.

A control method using an auxiliary circuit is described below to further reduce the voltage overshoot and recovery time of a DC-DC converter. The auxiliary circuit includes an auxiliary inductor and the auxiliary inductor current level is peak-current controlled (in boundary conduction mode-SCM) based on the negative load, transient step value. This simplified control method is suitable for multiphase Buck converters to reduce the switching frequency of the auxiliary circuit and maintain the converter's overall efficiency. A feature of this embodiment is that the number of switching cycles of the auxiliary circuit is predictable, and depends (approximately) on the ratio between main and auxiliary inductance.

The methods and circuits described herein, have the following features; 1) low frequency auxiliary circuit operation (for example, the switching frequency may be about 3× the switching frequency of the voltage converter) to reduce switching loss; 2) voltage overshoot reduction; 3) predictable auxiliary switching based on the main-auxiliary inductance ratio; and 4) minimized settling time of the unloading response based on charge balance principles.

The methods and circuits described herein are applicable to voltage converters such as Buck, forward, push-pull, half-bridge, and full-bridge converters. However, benefits of the present embodiments are greater in Buck converters than in most other converters or isolated converters. Accordingly, embodiments are described herein as applied to Buck converters.

I. Operating Principle

When a Buck converter responds to an unloading transient, the load current I₀ falls at a much higher slew rate than the output inductor I₀ current I_{L}. The output capacitor C₀ must absorb charge and thus increases voltage, resulting in an output voltage V₀ overshoot. Therefore, the current conducted through the output capacitor must be reduced to reduce the output voltage overshoot. The voltage overshoot may be reduced by modifying the output filter parameters; that is, by decreasing the size of the output inductor (resulting in decreased efficiency due to larger peak and thus RMS MOSFET current levels and/or increased switching frequency), or by increasing the size of the output capacitor (resulting in significantly higher cost of the Buck converter).

Alternatively, as described herein, the amount of charge absorbed by the output capacitor may be reduced by diverting excess current from the output inductor of the converter to the converter's input through operation of a controlled auxiliary circuit. A large reduction in the output voltage overshoot can be achieved using a properly designed auxiliary circuit. The auxiliary circuit requires only a small number of components and is thus inexpensive and relatively simple to implement. For example, in one embodiment the auxiliary circuit may comprise a small inductor, a switch, such, as a MOSFET, and a diode.

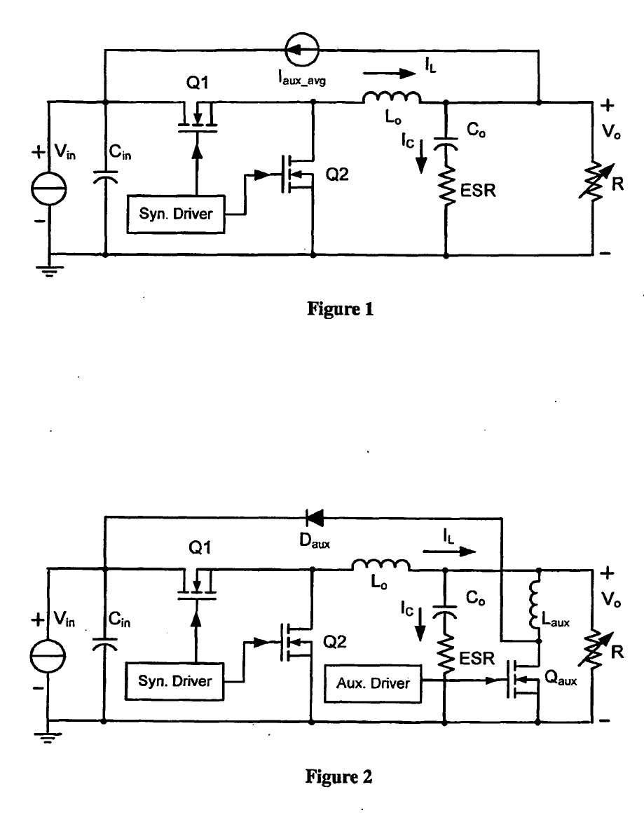

The auxiliary circuit may be modelled as a. controlled current source (referred to herein as a controlled auxiliary current (CAC)), drawing current from the output capacitor of the voltage converter and transferring it to the input of the voltage converter. FIG. 1 shows the model of such method when used with a synchronous Buck converter. The auxiliary circuit is only active during step-down load current transients (i.e., before and after an unloading transient, the voltage converter operates as a conventional converter (e.g., a Buck converter or a synchronous Buck converter).

FIG. 2 shows one embodiment of an auxiliary circuit as described herein. This embodiment includes an auxiliary inductor Lₐᵤₓ and series-connected auxiliary switch Qₐᵤₓ (e.g., a MOSFET or other suitable switching device), which are connected in parallel across the output capacitor of the converter. An auxiliary diode Dₐᵤₓ (e.g., a Schottky diode) is connected between the converter input and a node between Lₐᵤₓ and Qₐᵤₓ. In an alternative embodiment, a second MOSFET may be used in lieu of Dₐᵤₓ for synchronous rectification.

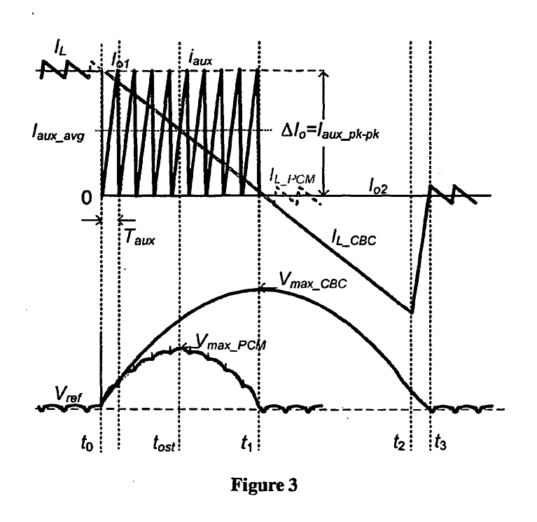

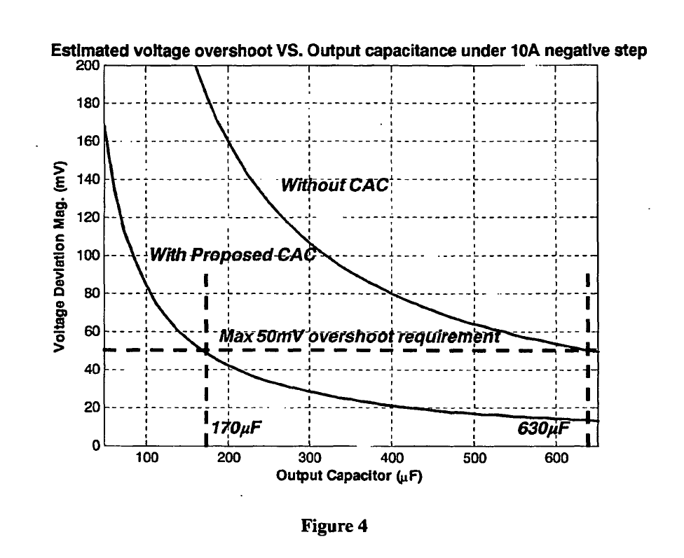

The methods and circuits described herein provide boundary conduction mode (BCM) peak current mode (PCM) controlled auxiliary current, as shown in the plot of FIG. 4. During steady state operation or a step-up loading transient, the GAC is deactivated and the voltage converter is regulated normally, e.g., by conventional feedback control, such as voltage mode control, although other circuits/schemes are also applicable, see e.g., [16], [17]). When an unloading transient occurs, the CAC rapidly removes the extra capacitor charge energy and transfers it back to the voltage converter input through the diode Dₐᵤₓ. Operation of the CAC and a control strategy therefor are described as follows, with reference to FIG. 3:

1. It is assumed that an unloading transient happens at t₀ triggering the control scheme to minimize the converter output voltage overshoot;

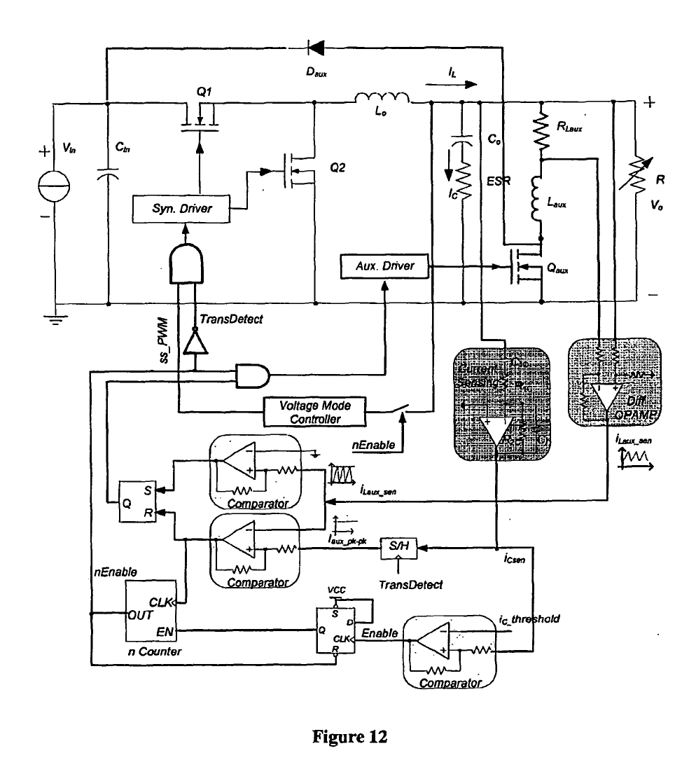

2. The main switch Q1 immediately turns off to reduce the additional capacitor charge at t₀, while a sample/hold (S/H) circuit sets the peak current reference value Iₐᵤₓ_{_{—}}ₚₖ₋ₚₖ by holding the output of a capacitor current sensing circuit (see the hardware embodiment of FIG. 12);

3. The auxiliary circuit is controlled using a peak current mode (at Iₐᵤₓ_{_{—}}ₚₖ₋ₚₖ) method in BCM (see FIG. 3), which can be approximately modelled as a current source connected between the converter output capacitor and the input voltage source to minimize the output voltage overshoot (see FIG. 1);

4. After n cycles of auxiliary switching (calculated as shown below), the output voltage recovers to the reference voltage V_{ref} at tₗ and normal control (e.g., voltage mode control) will take over regulation such that the settling time is optimized. As to the settling time, when the BCM peak current is set at Iₐᵤₓ_{_{—}}ₚₖ₋ₚₖ, equivalently, the average auxiliary current Iₐᵤₓ_{_{—}}_{avg} will be half of the transient load current step value ΔI₀; that is, Iₐᵤₓ_{_{—}}_{avg}=1/2 ΔI₀. Compared with a normal CBC controller (e.g., [1][5][17]), during the unloading transient, the auxiliary current rapidly balances the capacitor charge at t₁ (see FIG. 3). In contrast, without the help of the CAC, the output capacitor will be charged by the current (I_{L}-I₀₂) until t₁. Therefore, the CBC controller requires the negative portion of the Buck inductor L₀ current to discharge the capacitor. As soon as the capacitor charge is balanced the output voltage recovers to V_{ref} at t₃, as in a normal CBC controller (e.g., [5][17]). Thus, CAC coupled with CBC as described herein significantly reduces the settling time.

Furthermore, as shown in the plot of FIG. 4, in order to meet the overshoot requirement at, e.g., 50 mV under a 10 A step-down load transient, 630 μF output capacitance is required for a CBC controlled Buck converter without CAC, However, using a BCM PCM Controlled CAC, the required output capacitance can be reduced by 73.0% to 170 μF. As a result, the output capacitance may be implemented with a ceramic capacitor, resulting in reduced motherboard area and improved output voltage ripple.

Several unique features of the control strategy described herein are discussed below (see details in Section III). Firstly, the controlled auxiliary current is operated in the boundary condition mode (BCM) at reduced switching frequency (the CAC falls to zero at the end of each switching cycle), such that the switching power loss is decreased and a commonly used pulse width modulation (PWM) driver can he used to drive the auxiliary switch Q1. Also, because of the higher initial peak current of the auxiliary inductor, the output voltage overshoot will he lower compared to previous schemes (see e.g., [14]). furthermore, according to the design ratio between the output inductance (I₀) and the auxiliary inductance (Lₐᵤₓ), the number of auxiliary switching cycles n is predictable, which enhances the reliability of the control scheme. For example, if the output inductance L₀=1 μH and the auxiliary inductance Lₐᵤₓ˜100 nH, the number of auxiliary switching cycles will be n=9. The methods may he scaled and extended to multiphase voltage converters with much lower equivalent output inductance, whereas, in this circumstance, previous schemes may suffer from very high frequency switching or low auxiliary inductance for maintaining the average auxiliary current level.

II. Voltage Overshoot Estimation and Auxiliary Circuit Power Loss Analysis

Overshoot Estimation with Controlled Auxiliary Current

Without loss generality, it is assumed that the auxiliary circuit is switched for n times under BCM PCM control where integer n is the number of auxiliary switching cycles. Upon that the instantaneous output voltage variation can be expressed using equation (1) for two intervals depending on the ON/OFF state of the auxiliary circuit and the N^{th} time of switching* where Tₐᵤₓ is the switching period of the auxiliary current and dₐᵤₓ is the duty cycle of the auxiliary converter.

$$Δ {υ}_{o} ( t ) = \{ \begin{matrix}\begin{matrix}\frac{1}{{C}_{o}} [ Δ {I}_{o} \cdot t - \frac{{V}_{o}}{2 {L}_{o}} {t}^{2} - \frac{N \cdot Δ {I}_{o} \cdot {T}_{aux}}{2} - {\int }_{0}^{( t - N \cdot {T}_{aux} )} \frac{{V}_{o}}{{L}_{aux}} t \cdot d t ] \\ ( N {T}_{aux} \leq t < N {T}_{aux} + {d}_{aux} {T}_{aux} ) ( N = 0 , 1 , 2 … , n )\end{matrix} \\ \frac{1}{{C}_{o}} [ \begin{matrix}Δ {I}_{o} \cdot t - \frac{{V}_{o}}{2 {L}_{o}} {t}^{2} - \frac{N \cdot Δ {I}_{o} \cdot {T}_{aux}}{2} - \frac{{V}_{in} - {V}_{o}}{2 {V}_{in}} {T}_{aux} Δ {I}_{o} - \\ {\int }_{( t - N \cdot {T}_{aux} - {d}_{aux} {T}_{aux} )}^{{T}_{aux}} \frac{( {V}_{in} - {V}_{o} ) ( {T}_{aux} - t )}{{L}_{aux}} d t\end{matrix} ] \\ ( N {T}_{aux} + {d}_{aux} {T}_{aux } \leq t < ( N + 1 ) {T}_{aux} ) ( N = 0 , 1 , 2 … , n )\end{matrix} \qquad ( 1 )$$

The output overshoot/maximum voltage occurs at the time tₒₛₜ in (2), when the derivative of equation (1) is zero during the (N′1) switching, where N′ is calculated in equation 3) depending on the parity of n.

$$\begin{matrix}{t}_{ost} = \frac{{D}_{aux} + {N}^{′}}{{D}_{aux} + n} \cdot n {T}_{aux} & ( 2 ) \\ {N}^{′} = \{ \begin{matrix}\frac{n - 1}{2} ( when n is odd ) \\ \frac{n}{2} - 1 ( when n is even ) \end{matrix} & ( 3 )\end{matrix}$$

Based on the average auxiliary current Lₐᵤₓ_{_{—}}_{avg} without considering the auxiliary inductor current ripple under the BCM peak current control, a simplified equation is provided as a practical method to calculate the overshoot in equation (4). The symbols L₀, C₀, ESR, ΔI₀, V₀ and Lₐᵤₓ represent the output inductance, output capacitance, equivalent series resistance, load step value, output voltage, and the auxiliary inductance, respectively.

$$Δ {V}_{o} \approx \frac{E S R \cdot {C}_{o}^{2} \cdot {V}_{o}^{2} + {( \frac{Δ {I}_{o}}{2} )}^{2} \cdot {L}_{o}^{2}}{2 {V}_{o} \cdot {L}_{o} \cdot {C}_{o}} + \frac{{( \frac{Δ {I}_{o}}{2} )}^{2} \cdot {L}_{aux}^{2}}{2 {V}_{o} \cdot {C}_{o}} \qquad ( 4 )$$

Another feature of the methods and circuits described herein is that under a certain value of step-down load transient, the number n of auxiliary switching cycles may be predicted using the input and output voltage information as well as the inductance ratio of L₀ and Lₐᵤₓ. The number of switching cycles n may be estimated using equation (5), where [ ]ᵢₙₜ indicates the rounding down operation. It is noted that n is independent of the load transient step value ΔI₀.

$$n = {[ \frac{( {V}_{in} - {V}_{o} ) {L}_{o}}{{L}_{aux} \cdot {V}_{in}} + 0.5 ]}_{int} \qquad ( 5 )$$

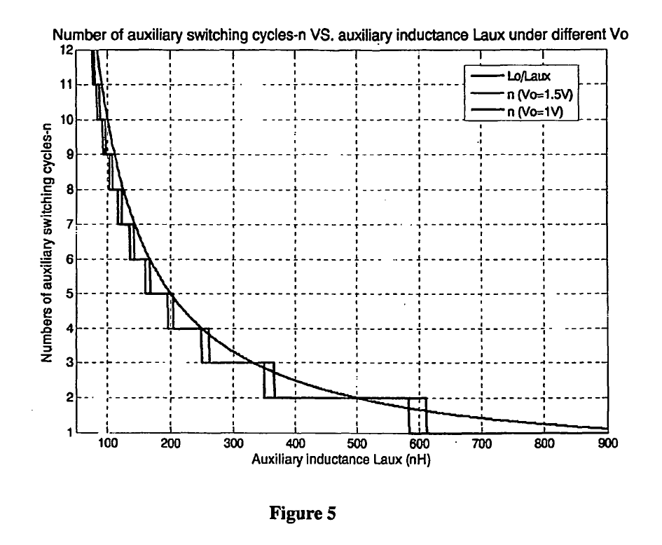

FIG. 5 shows the relationship between the number of auxiliary switching cycles n (as well as the ratio of L₀/Lₐᵤₓ) and the auxiliary inductance value under different output voltages V₀. Based on the power circuit design parameters (Vᵢₙ, V₀, L₀, and Lₐᵤₓ), the necessary cycles of auxiliary switching for fast recovering the overshoot may be counted by a counter for n. This way the CBC controller can deactivate the CAG as soon as the count reaches n.

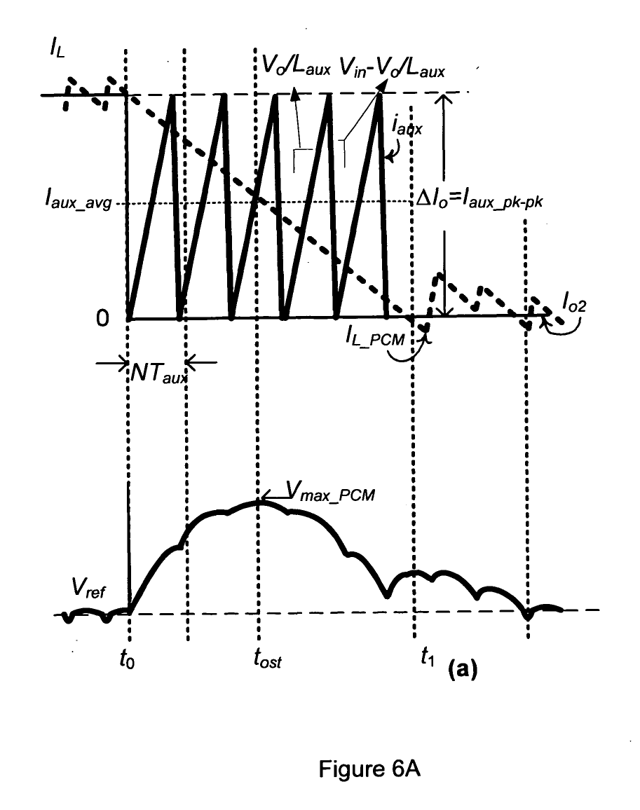

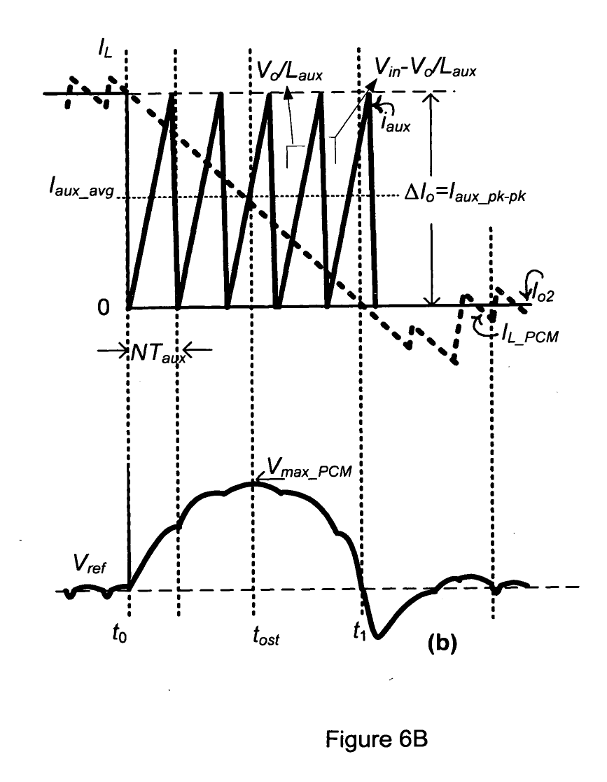

FIG. 6 illustrates the impact of the rounding down operation of n on the settling time. In FIG. 6(a), where ([(Vᵢₙ-V₀)/Vᵢₙ*L₀/Lₐᵤₓ]-n<0.5), the CAC is deactivated before the inductor current reaches the new load level I₀₂. In this case a second overshoot occurs and the settling time is longer than the ideal ease shown in FIG. 3. However, when ([Vᵢₙ-V₀)/Vᵢₙ*L₀/Lₐᵤₓ]-n≧0.5), as shown in FIG. 6(b), the CAC is activated longer than required, so that a voltage undershoot appears, and the settling time is increased. However, it is noted that the output overshoot equations in (1) are still valid because they are actually not dependent on n. The time instant tₒₛₜ. may he expressed more generally in (6).

$${t}_{ost} = \frac{Δ {I}_{o} + \frac{{V}_{o}}{{L}_{aux}} N {T}_{aux}}{\frac{{V}_{o}}{{L}_{o}} + \frac{{V}_{o}}{{L}_{aux}}} = \frac{Δ {I}_{o} \cdot {L}_{aux} {L}_{o} + {V}_{o} \cdot N {T}_{aux} \cdot {L}_{o}}{{V}_{o} ( {L}_{aux} + {L}_{o} )} \qquad ( 6 )$$

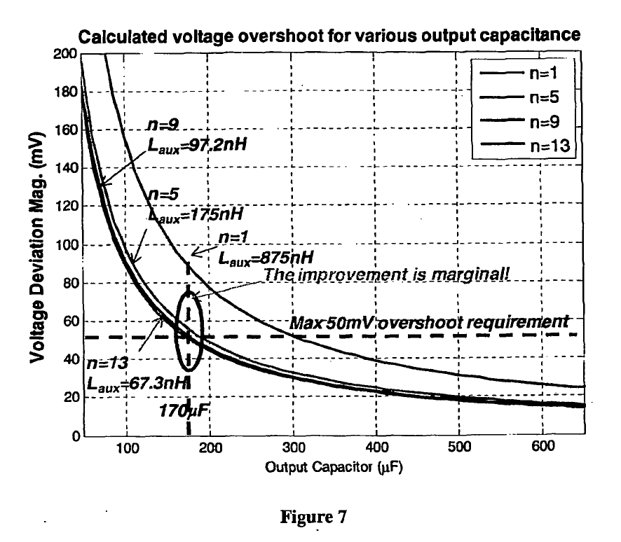

FIG. 7 gives the overshoot voltage for various numbers of auxiliary switching cycles using the BCM PGM controlled auxiliary current By choosing proper auxiliary inductance Lₐᵤₓ, the number of auxiliary switching cycles n may be controlled according to equation (5).

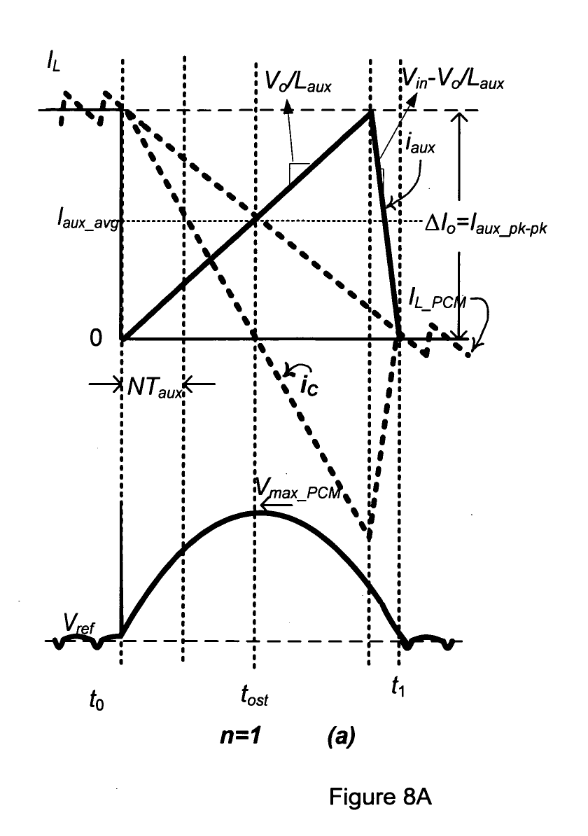

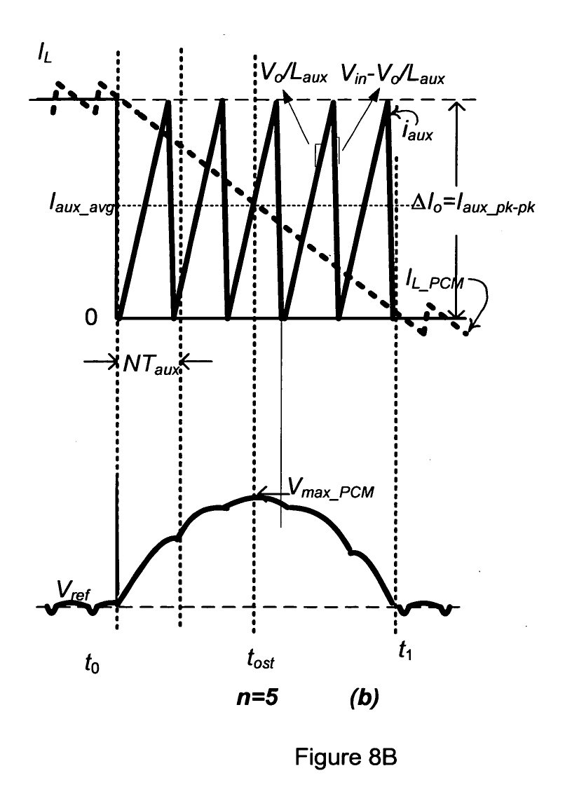

For example, as shown in FIG. 8, n=1 means that in order to meet the overshoot requirement, the auxiliary circuit will be activated for one switching cycle during the unloading transient which may be achieved by selecting Lₐᵤₓ875 nH and output capacitance C₀=300 μF, as shown in FIG. 8(a). As another example, for n=5, the auxiliary circuit will he activated for 5 switching cycles by selecting Lₐᵤₓ=1.75 nH and C₀=185 μF, as shown in FIG. 8(b).

It is also noted from FIG. 7 that the lower the auxiliary inductance Lₐᵤₓ is the more the number n of auxiliary switching cycles and the better the unloading transient performance will be. However, from the simulation result shown in FIG. 5, the improvement is marginal when the auxiliary inductance Lₐᵤₓ becomes small (i.e., Lₐᵤₓ<100 nH, N<9). On the contrary, small Lₐᵤₓ will increase the auxiliary switching frequency fₐᵤₓ and harm the overall efficiency due to the resulting increase in number of auxiliary switching cycles.

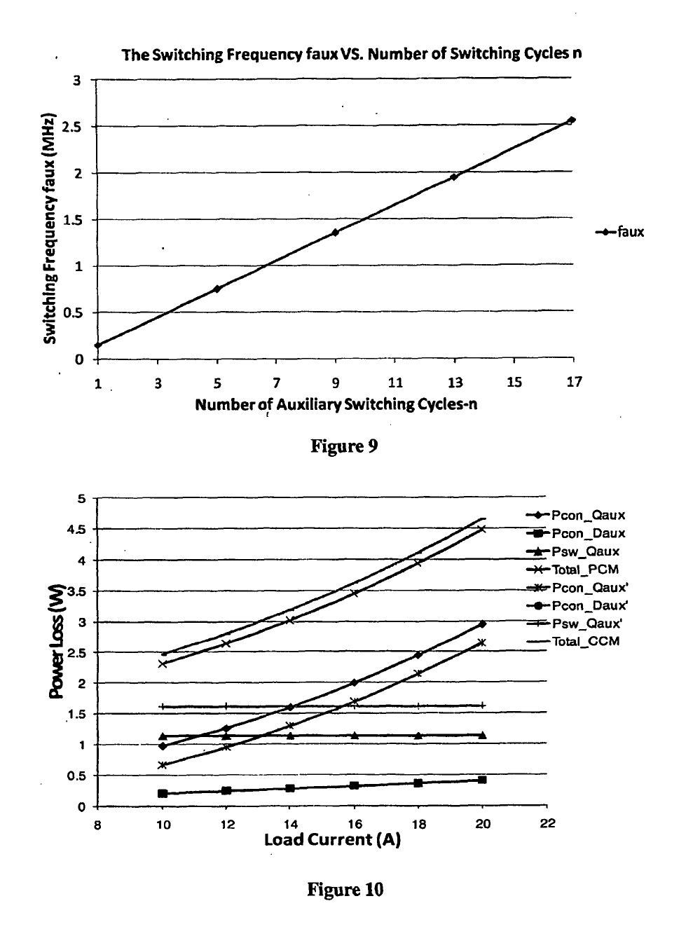

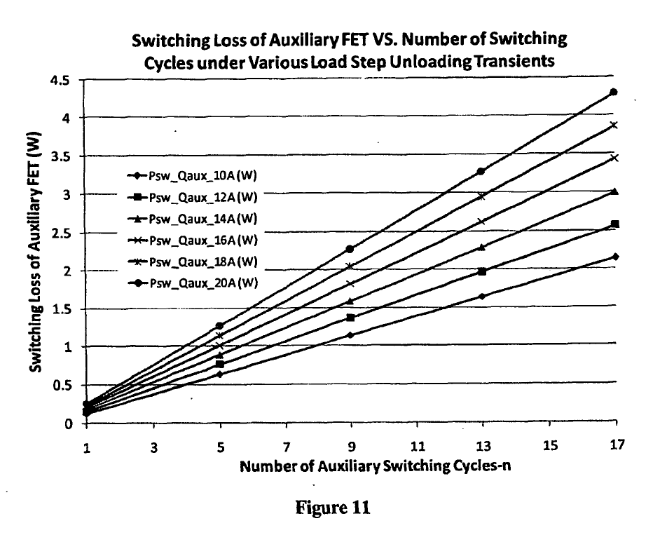

FIG. 9, shows that the switching frequency of the auxiliary MOSFET fₐᵤₓ increases linearly with n. When the switching frequency fₐᵤₓ is much higher than 1 MHz, the cost of the auxiliary MOSFET driver will increase dramatically, resulting in higher cost of the CAC implementation. Therefore, design comprise should be made for output voltage overshoot and switching frequency/switching loss of the auxiliary circuit.

### Special Case

The current patterns may be controlled as an average current source of Iₐᵤₓ_{_{—}}_{avg}, such as in FIG. 3. The control method in [14] may be considered a special case of the methods described herein. Instead of controlling the current using BCM, in the special case, the current ripple Iₐᵤₓ_{_{—}}ₚₖ₋ₚₖ is much smaller than the load step value ΔI₀. The peak current level can be set to Iₐᵤₓ_{_{—avg}}+0.5* Iₐᵤₓ_{_{—pk-pk}} and the auxiliary switching frequency can be calculated by equation (7)/ When the auxiliary current reaches the peak current level, the auxiliary switch is turned off until the current reduces Iₐᵤₓ_{_{—}}_{avg}-1/2I_{aux,pk-pk}. If the auxiliary switching frequency is high enough, the current ripple I_{aux,pk-pk} can be ignored and the estimated total activation time of the auxiliary current T_{act} (or the operation time of the auxiliary circuit) can be simply expressed using equation (8) and shown in FIG. 3.

$$\begin{matrix}\begin{matrix}{f}_{aux} = \frac{1}{{T}_{aux}} \\ = \frac{1}{( \frac{{I}_{{aux}_{pk} - pk}}{{V}_{o}} - \frac{{I}_{{aux}_{pk} - pk}}{{V}_{in} - {V}_{o}} ) \cdot {L}_{aux}}\end{matrix} & ( 7 ) \\ {T}_{act} = \frac{Δ {I}_{o} \cdot {L}_{o}}{{V}_{o}} - \frac{Δ {I}_{o} \cdot {L}_{aux}}{2 {V}_{o}} & ( 8 )\end{matrix}$$

Auxiliary Circuit Power Loss Analysis

There are three main sources of conduction loss in the auxiliary circuit, the auxiliary inductor Iₐᵤₓ, the auxiliary MOSFET Qₐᵤₓ, and the auxiliary diode Dₐᵤₓ.

By calculating the RMS auxiliary current using equation (9), the inductor conduction loss may be calculated. In the loss analysis, due to the very low DCR and sensing resistance R_{Laux} of the auxiliary inductor Lₐᵤₓ (about 0.2 mΩ in total), the auxiliary inductor conduction loss is in the order of 10 mW and may be ignored.

$${I}_{aux ( rms )} = {I}_{aux\_av g} \sqrt{1 + \frac{1}{3} {( \frac{{I}_{aux\_pk - pk}}{2 {I}_{aux\_av g}} )}^{2}} \qquad ( 9 )$$

The RMS current of the auxiliary MOSFET and the average current of the auxiliary diode maybe calculated using equations (10) and (11).

$$\begin{matrix}{I}_{Qaux ( rms )} = {I}_{aux\_av g} \cdot \sqrt{\frac{{V}_{in} - {V}_{o}}{{V}_{in}}} \sqrt{1 + \frac{1}{3} {( \frac{{I}_{aux\_pk - pk}}{2 {I}_{aux\_av g}} )}^{2}} & ( 10 ) \\ {I}_{Daux ( avg )} = {I}_{aux\_avg} ( 1 - \frac{{V}_{in} - {V}_{o}}{{V}_{in}} ) & ( 11 )\end{matrix}$$

The conduction loss for the auxiliary MOSFET and auxiliary diode can be calculated using (12) and (13).

P_{con}_{_{—}}_{Qaux}=I²_{Qaux(rms)}.R_{Qaux} (7)

P_{con}_{_{—}}_{Daux}=I_{Daux(rms)}.V_{diode} (8)

When a Schottky diode is used, it may be assumed that, the switching loss of the diode is negligibly small compared to the MOSFET switching loss and the total conduction loss. Generally, the switching loss for the auxiliary MOSFET can be calculated using (14), where Tᵣₒₛₑ is the rise time of the auxiliary MOSFET and Iₒₙ is the instantaneous auxiliary current when Qₐᵤₓ is turned on, respectively, T_{fall} equals the typical fall time of the auxiliary MOSFET. I_{off} equals the instantaneous auxiliary current when Qₐᵤₓ is turned off, which is equal to the peak auxiliary current

$${P}_{sw\_Qaux} = \frac{1}{2} {f}_{aux} \cdot {V}_{in} \cdot ( {T}_{rise} \cdot {I}_{on} + {T}_{fall} \cdot {I}_{off} ) \qquad ( 9 )$$

Because of the aero turn-on current under BCM operation of the CAC, the switching loss of the auxiliary MOSFET can be simplified as in equation (15).

$${P}_{sw\_Qaux} = \frac{1}{2} {f}_{aux} \cdot {V}_{in} \cdot {T}_{fall} \cdot {I}_{off} \qquad ( 15 )$$

In FIG. 10, according to the previous equations, the power loss analysis is shown for comparison between the BCM PCM control strategy described herein and the continuous conduction mode (CCM) control scheme, The conduction loss of the auxiliary MOSFET and the Schottky diode, MOSFET switching loss, and total losses are represented as Pcon_Qaux, Pcon_Daux, Psw_Qsw and Total_PCM for the BCM PCM control strategy, whereas Pcon_Qaux′, Pcon_Daux′, Psw_Qsw′ and Total_CCM are used for the CCM control scheme [14]. It is noted that the conduction loss of the auxiliary diode is unchanged using the BCM PCM scheme because of the same average current. The conduction loss of the auxiliary MOSFET using the BCM PCM controller is higher than that of the auxiliary MOSFET controlled by the CCM scheme due to the larger inductor current ripple, thus, the RMS current value. However, compared to the CCM scheme, the switching loss of the auxiliary MOSFET and the total losses are reduced using the BCM PCM controlled CAC. It is also noted that the auxiliary MOSFET switching loss is independent of the load current level.

Although the total loss of the CAC is around 4.5 W under a 20 A load current, the activation interval is only during an unloading transient condition, for which the duration is typically in the order of several microseconds, As a result, thermal issues are not of concern.

The switching losses were simulated under different values of step unloading transients (from 10 A to 20 A) as shown in FIG. 1. Compared to the case where n=13, when the number of auxiliary switching cycles n equals 9, the overshoot is only higher by 1 mV (see FIG. 5), whereas the switching frequency ∫ₐᵤₓ and loss P_{sw}_{_{—}}Qₐᵤₓ are reduced by ⅓. Thus the auxiliary inductance Lₐᵤₓ may he selected to be 100 nH to achieve a good design, considering the trade-off between overshoot improvement and power losses.

III. Implementation of BCM PCM Controlled Auxiliary Current Strategy

A diagram of a hardware implementation of the BCM PCM strategy to control the CAC is shown in the embodiment of FIG. 12. To set the peak current level of the auxiliary current, the load step value is required to be sensed/calculated. The ac component of the capacitor current during a load transient is an alternative representation of the load step ΔI₀. Therefore the capacitor current can be rebuilt by active filtering of the output voltage (e.g., by considering the capacitor equivalent series resistance (ESR) in equation (16)) with an extra pole provided by C_{∫} to attenuate the switching noise.

$$\begin{matrix}{C}_{1 C} \cdot {R}_{1 C} = ( \frac{{C}_{o}}{k} ) \cdot ( E S R \cdot k ) \\ = {C}_{o} \cdot E S R\end{matrix} \qquad ( 16 )$$

The output of the capacitor current sensor i_{Csen}, in relation to the actual capacitor current i_{C} is equated in (17).

$${i}_{Csen} = \frac{{R}_{2 C}}{k} {i}_{C} \qquad ( 17 )$$

Other capacitor current sensing circuits (sees e.g., [14]) can also be used in this implementation.

In the embodiment of FIG. 12, the nCounter (for counting the switching cycles of the auxiliary circuit) generates a TransDetect signal to hold the Iₐᵤₓ_{_{—}}ₚₖ₋ₚₖ value. A differential OPAMP amplifies the voltage across the current sensing resistor R_{Laux} to equalize the auxiliary current iₐᵤₓ, which is compared with Iₐᵤₓ_{_{—}}ₚₖ₋ₚₖ and GND. An SR flip-flop is used to create the PWM signal to the auxiliary driver for switching Qₐᵤₓ and implement the BCM operation. When the nCounter reaches n (that is, the desired number of auxiliary switching cycles), the nEnable (OUT) signal of the nCounter will: 1) deactivate the auxiliary current; 2) reset the EN signal; and 3) generate the CBC PWM signal for the voltage converter.

IV. Simulation and Experimental Verification

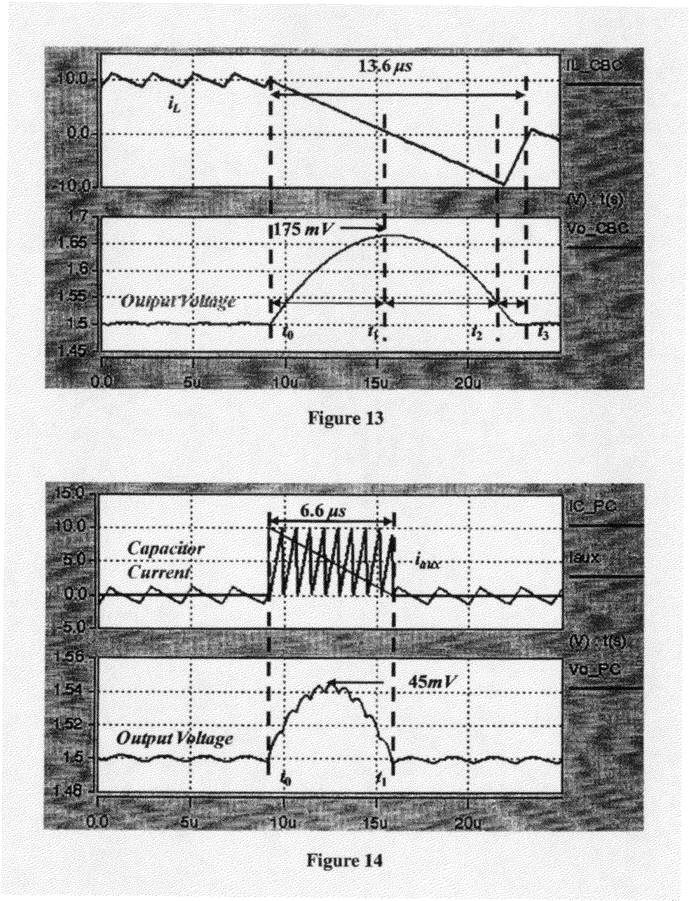

In order to verity tire functionality of the BCM PCM control strategy, a Buck, converter with/without CAC undergoing an unloading transient condition was simulated. The simulation results are shown in FIG. 13 and FIG. 14 for comparison between a CBC controller as in [14] and a BCM PCM controlled CAC during a 10 A unloading transient. The design parameters were: Vᵢₙ=12 V, V₀=V_{ref}=1.5 V, ƒₛ=450 kHz, L₀=1 μH, R_{L}=1 mΩ, C₀=200 μF, ESR=0.1 mΩ, ESL=100 pH, Lₐᵤₓ=100 nH, R_{Laux}=0.2 mΩ, R_{Qaux}=30 mΩ, V_{diode}=0.32 V, T_{fall}=2 ns, and n=9 (using equation (5), Vᵢₙ-V₀/Vᵢₙ*L₀/Lₐᵤₓ−8.75). The Type III compensator in the CBC controller was well-designed with 75 kHz bandwidth and 60° phase margin as in [14].

In. FIG. 13, the previously discussed CBC control technology was employed for optimal response of the single phase Buck converter. The overshoot was 175 mV with 13.6 μs settling time under a 10 A step-down load transient.

For the BCM PCM controlled CAC, the output voltage overshoot was reduced to 45 mV and the settling time was reduced to 6.6 μs, compared to the CBC controlled Buck converter without CAC. In other words, the overshoot and the settling time were improved by 74.2% and 51.5%, respectively.

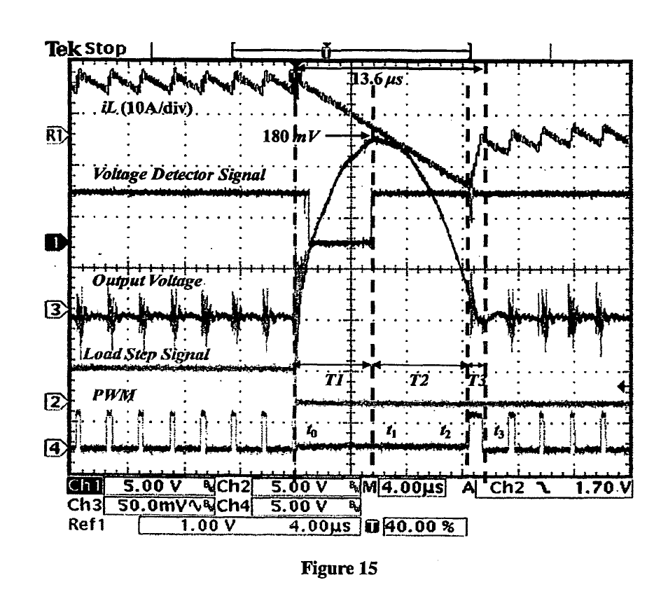

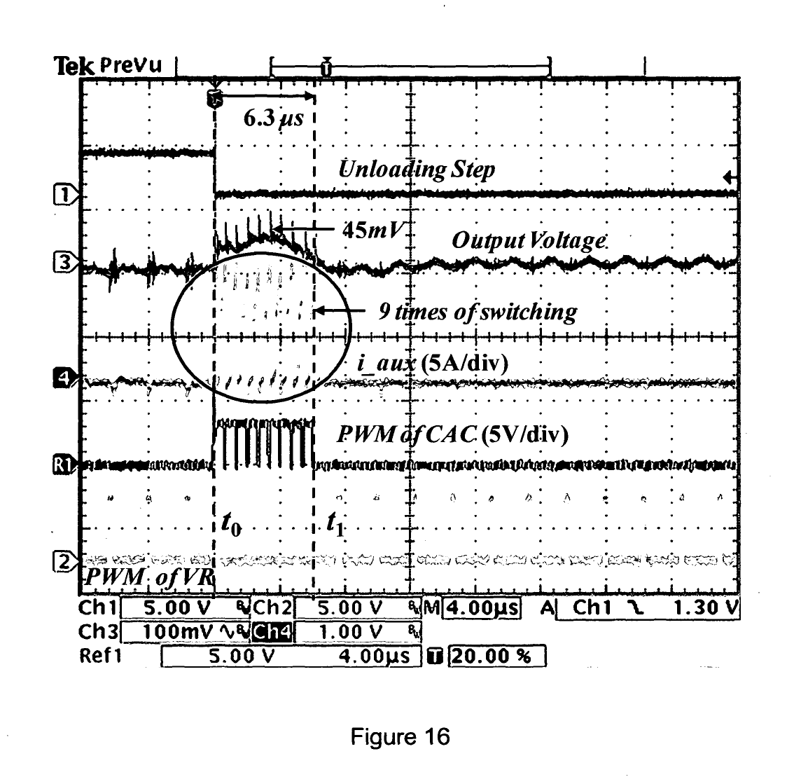

A single phase 12 V-1.5 V prototype was built with CAC using the same parameters as in the above simulation. Experimental results are shown In FIG. 15 and FIG. 16, under an unloading transient between full load (10 A) and no load. Using the proposed BCM PCM controlled CAC, the overshoot was decreased by 75.0% and the settling time was shortened by 53.6%, compared with the optimal, response provided by an analog CBC controller without CAC (as in [14]). The number of switching cycles was predicted using (11) and in the experiment the rounded off number n was 9.

V. Further Embodiments

Further embodiments and examples are described as provided in the attached Appendices A to E.

All cited publications are incorporated herein by reference in their entirety.

Equivalents

Those of ordinary skill in the art will recognize, or be able to ascertain through routine experimentation, equivalents to the embodiments described herein. Such embodiments are within the scope of the invention and are covered by the appended claims.

### REFERENCES

[1] G. Feng, E. Meyer, and Y-F. Liu, “A new digital control algorithm; to achieve optimal dynamic performance in DC-to-DC converters/” IEEE Trans, Power Electron, vol. 22, no. 4, pp. 1489-1498, July 2007.

[2] T. Geyer, G. Papafotiou, R. Frasea, and M, Morari, “Constrained optimal control of step-down DC-DC converter.” IEEE Trans. Power Electron, vol. 23, no. 5, pp. 2454-2464, September 2008.

[3] S, Gomariz, E. Alarcon, J. A. Martinez, A. Poveda, J. Madrenas, and F, Guinjoan, “Minimum time control of a buck converter by means of fuzzy logic approximation,” in. Proc. IEEE 24th Annu. Conf. Ind. Electron. Soc. (IECON 1998), vol. 2, pp. 1060-1065.

[4] K, K. S. Leung and H. S. H. Chung, “A comparative study of boundary control with first- and second-order switching surfaces for buck converters operating in DCM,” IEEE. Trans. Power Electron., vol. 22, no. 4, pp, 1196-1209, July 2007.

[5] K. K. S. Leung and H. S. H. Chung, “Derivation of a second-order switching surface in the boundary control of buck converters,” IEEE Power Electron, Letters, vol. 2, no. 2, pp. 63-67, June 2004.

[6] E. Meyer, Z. Zhang, and Y.-F, Liu, “An optimal control method for buck converters using: a practical capacitor charge balance technique,” IEEE Trans. Power Electron. vol. 23, no. 4, pp. 1802-1812, July 2008.

[7] M. Oronez, M. T. Iqbal, and J. E. Quaicoe, “Selection of a curved switching surface for buck converters,” IEEE Trans. Power Electron., vol. 21, no. 4, pp. 1148-1153, July 2006.

[8] A. Soto, A. de Castro, P. Alou, J. A. Cobos, J Uceda, and A. Lofti, “Analysis of the buck converter for scaling the supply voltage of digital circuits,” IEEE Trans. Power Electron., vol. 22, no. 6, pp. 2432-2443, November 2007.

[9] V. Yonsefzadeh, A. Babazadeh, B. Ramachandran, E. Alarcon, L. Pao, and D, Maksimovie, “Proximate time-optimal digital control for synchronous buck DC-DC converters,” IEEE Trans. Power Electron., vol. 23, no. 4, pp. 2018-2020, July 2008.

[10] Z. Zhao and A. Prodie, “Continuous-time digital controller for high frequency DC-DC converters,” IEEE Trans. Power Electron., vol., 23, no. 2, pp. 564-573, March 2008.

[11] P. Alou, J. A. Cobos, R. Prieto, O. Garcia, and J, Uceda, “A two stage voltage regulator module with fast transient response capability,” in IEEE Power Electron. Spec. Conf. (PESC), June 2003, vol. 1, pp. 138-143.

[12] Y. Ren, M. Xu, K. Yao, Y. Meng, and F. C. Lee, “Two-stage approach for 12-V VR,” IEEE Trans. Power Electron., vol. 19, no. 6, pp. 1498-4506, November 2004.

[13] R. Singh and A. Khambadkone. “A buck derived topology with improved step-down transient performance,” IEEE Trans. Power Electron., vol. 23, no. 6, pp. 2855-2866, November 2008.

[14] E. Meyer, Z. Zhang and Y. F. Liu, “Controlled Auxiliary Circuit to Improve the Unloading Transient Response of Buck Converters”, IEEE Trans. Power Electron., Vol. 25, No. 4, April 2010, pp. 806-819.

[15] W. J. Lambert, R. Ayyanar and S. Chiekamenahalli, “Fast Load Transient Regulation of Low-Voltage Converters with the Low-Voltage Transient Processor”, IEEE Pram. Power Electro., vol. 24, no. 7, pp. 1839-1854, July 2009.

[16] Y. F. Liu and L. Jia “Performance Enhancement with Digital Control Technologies for DC/DC Switching Converters, ” in 12th IEEE Workshop on Control and Modeling for Power Electronics (COMPEL 2010), University of Colorado, Boulder, Colo., USA.

[17] L. Jia, D. Wang, Y. F. Liu, and P Sen “A Novel Fully Analog Implementation of Capacitor Charge Balance Controller with a Practical Extreme Voltage Detector,” in IEEE The Applied Power Electronics Conference and Exposition (APEC) 2011, Fort Worth, Tex., USA.

1. A method for operating a DC-DC converter; comprising:
using a controlled auxiliary current to divert current from an output capacitor of the DC-DC converter to an input of the DC-DC converter during an unloading current step;
wherein controlling the controlled auxiliary current comprises using at least one switch and operating the at least one switch for a selected constant number of switching cycles;
wherein the method minimizes output voltage deviation of the DC-DC converter during the unloading current step.

2. The method of claim 1, comprising controlling the controlled auxiliary current using a peak current mode-boundary condition mode.

3. The method of claim 1, comprising selecting the number of switching cycles using parameters of the DC-DC converter, including input and output voltage information and a ratio of output inductor and auxiliary inductor values.

4. The method of claim 3, comprising controlling the controlled auxiliary current by activating the auxiliary current, setting a peak current level, and deactivating the auxiliary current when the auxiliary current reaches the peak current level.

5. The method of claim 4, including setting a switching frequency of a switch of the controlled auxiliary current.

6. The method of claim 1, wherein the DC-DC converter comprises a Buck converter.

7. A DC-DC converter; comprising:
a controlled auxiliary current circuit comprising at least one auxiliary switch that diverts current from an output capacitor of the DC-DC converter to an input of the DC-DC converter during an unloading current step; and
a control circuit that controls operation of the controlled auxiliary current circuit;
wherein the control circuit operates the at least one auxiliary switch for a selected number of switching cycles to divert current from the output capacitor of the DC-DC converter to the input of the DC-DC converter during the unloading current step;
wherein the controlled auxiliary current circuit minimizes output voltage deviation of the DC-DC converter during the unloading current step.

8. The DC-DC converter of claim 7, wherein the controlled auxiliary current circuit comprises:
a series circuit including an auxiliary inductor and the at least one auxiliary switch, the series circuit connected in parallel with the output capacitor of the DC-DC converter; and
a diode or a second swatch connected between the input of the DC-DC converter and a point between the inductor and the at least one auxiliary switch.

9. The DC-DC converter of claim 7, wherein the control circuit uses peak current mode-boundary condition mode to control the controlled auxiliary current circuit.

10. The DC-DC converter of claim 7, wherein the control circuit determines the selected number of switching cycles based on parameters of the DC-DC converter, including input and output voltage information and a ratio of output inductor and auxiliary inductor values.

11. The DC-DC converter of claim 7, wherein the control circuit activates the controlled auxiliary current, sets a peak current level, and deactivates the controlled auxiliary current when the auxiliary current reaches the peak current level.

12. The DC-DC converter of claim 7, wherein the control circuit sets a switching frequency of the auxiliary switch.

13. The DC-DC converter of claim 7, wherein the DC-DC converter comprises a Buck converter.

14. A controller for a DC-DC converter; comprising:
a circuit that controls operation of an auxiliary current circuit including at least one auxiliary switch that diverts current from an output capacitor of the DC-DC converter to an input of the DC-DC converter during an unloading current step;
wherein the circuit operates the at least one auxiliary switch for a selected number of switching cycles to divert current from the output capacitor of the DC-DC converter to the input of the DC-DC converter during the unloading current step;
wherein the auxiliary current circuit minimizes output voltage deviation of the DC-DC converter during the unloading current step.

15. The controller of claim 14, wherein the controlled auxiliary current circuit comprises:
a series circuit including an auxiliary inductor and the at least one auxiliary switch, the series circuit connected in parallel with the output capacitor of the DC-DC converter; and
a diode or a second switch connected between the input of the DC-DC converter and a point between the inductor and the at least one auxiliary switch.

16. The controller of claim 14, wherein the circuit uses peak current mode-boundary condition mode to control the auxiliary current circuit.

17. The controller of claim 14, wherein the circuit determines the selected number of switching cycles based on parameters of the DC-DC converter, including input and output voltage information and a ratio of output inductor and auxiliary inductor values.

18. The controller of claim 14, wherein the circuit activates the auxiliary current, sets a peak current level, and deactivates the auxiliary current when the auxiliary current reaches the peak current level.

19. The controller of claim 14, wherein the circuit sets a switching frequency of the auxiliary switch.

20. The controller of claim 14, wherein the DC-DC converter comprises a Buck converter.
